(19) United States
(12) Patent Application Publication
(10) Pub. No.: US 2009/0216968 A1
(43) Pub. Date: Aug. 27, 2009

(54) Method and apparatus for storing sequential sample data as memories for the purpose of rapid memory recognition using mathematic invariants

(76) Inventors: Gregory D. Martin, Georgetown, TX (US); Don D. Bain, Devon, PA (US)

Correspondence Address: BUCHANAN, INGERSOLL & ROONEY PC, POST OFFICE BOX 1404, ALEXANDRIA, VA, 22313-1404, US

(21) Appl. No.: 12/379,735

(22) Filed: Feb. 27, 2009

Related U.S. Application Data
(60) Provisional application No. 61/064,317, filed on Feb. 27, 2008.

(51) Int. Cl. G06F 12/00; G06F 12/02; G06F 12/16

(52) U.S. Cl. 711/161; 711/170; 711/E12.001; 711/E12.002; 711/E12.103; 706/21; 706/48

(57) ABSTRACT

The invention described herein provides a method and apparatus for storing information in a memory structure and determining mathematical invariants in the memory structure. These invariants are then used to predict nested data patterns given only a few data elements or given incomplete data elements. The method uses a Memory Recognition Engine (MRE) that memorizes everything it processes. The MRE method can be applied to any problem where data sequences are involved that generate patterns only or nested patterns.

### CROSS-REFERENCE TO RELATED APPLICATIONS

This application claims the benefit of U.S. Provisional Patent Application No. 61/064,317, filed on Feb. 27, 2008, in the United States Patent and Trademark Office, the disclosure of which is incorporated herein in its entirety by reference.

### BACKGROUND

1. Field of the Invention

The invention relates to a system and method for storing measurement information, observations or other data in a memory structure and determining mathematical invariants in the memory structure. These invariants are then used to predict nested data patterns given only a few sample data elements or given incomplete sample data. Predicted patterns may be used for significant advantage, depending of the context and domain. The method uses a Memory Recognition Engine (MRE) that memorizes everything it observes. The MRE method can be applied to any problem where sample data are involved that generate patterns only or nested patterns.

2. Background Summary

The human neocortex comprises 6 thin layers of cells on the outer portion of the brain. It processes all human activities in terms of stored memories as described in Hawkins (Hawkins, J. and S. Blakeslee, On Intelligence, Henry Hold and Company, New York, 2004) incorporated herein by reference. Of particular interest to the investigators are the concepts in Hawkins of memories organized in a hierarchy, the emergence and importance of patterns in memories, the utility of invariant memory forms and the important role of predictions of patterns based on modest input signal yielding substantial advantages including optimizing limited cortical processing resources.

### SUMMARY

This disclosure describes a Memory Recognition Engine (MRE) that uses memories composed of multi-layered, hierarchical memory patterns, with the novel addition of a memory occurrence count stored with each stored memory.

Six layers of memory hierarchy are implemented in the MRE test bed, with the choice of 6 taken from the human neocortex structure. There is no limitation of the engine to any particular number of layers.

The initial goal of the MRE investigation was to store memory patterns and use that stored information to predict patterns given only a little input. This would be useful in spacecraft telemetry, where there is, for example, a 20-second delay in signal transmission due to the speed of light. It would be useful for the spacecraft to recognize a command given only a few segments of the total signal that comprises that command.

A MRE was constructed in a general purpose computer and many sets of input data were processed by the MRE. The ability to predict patterns based on little input was demonstrated. Also demonstrated was the ability to recognize patterns in the presence of data drop outs. Study of the patterns that emerged in the memory count data revealed unique insights that are the basis of the claims made herein.

Rollett (Rollett, John M., Pattern recognition using stored n-tuple occurence frequencies; U.S. Pat. No. 5,065,431, 1991) incorporated herein by reference presents pattern recognition using stored n-tuples (arrays), and uses it for e.g. speech recognition based on occurrence frequencies. The method is “trained” by repeatedly reading a word into the recognizer and the recognizer analyzes frequency patterns and stores them. Then, in recognition mode, the method reads speech signals and processes the pattern matching algorithm to see if word matches are made. In matching mode the method can also create new word patterns, forgetting the old ones. In this way it can learn the changes in how an individual says a certain word.

The description in Rollet can also be applied to the overall operation of the MRE. The MRE stores memories in arrays, and it processes occurrence incidences. One fundamental difference between the method of Rollett and the MRE is that the MRE processes occurrence incidences in sequential order of appearance, not in whole, as in Rollett. Also, the MRE processes patterns of adjacent sequential occurrence incidences. This is one of the fundamental mathematical invariants used by the MRE. Moreover, it processes patterns of patterns of adjacent sequential occurrence incidences. This is the high-level invariant used by the MRE to quickly detect complex patterns.

### BRIEF DESCRIPTION OF THE FIGURES

These and further features of the invention will be apparent with reference to the following description and figures, wherein:

FIG. 1 shows the implementation of MRE in general purpose computer.

FIG. 2 shows loading memory data in a memory array location.

FIG. 3 shows the loading subsequent input data into memory locations.

FIG. 4a shows the first instance of memory data processing and the first level of memory storage.

FIG. 4b shows the subsequent instances of memory data processing and the first level of memory storage.

FIG. 5 shows memory data processing for a simple music example.

FIG. 6 shows memory data processing in subsequent levels as a hierarchy.

FIG. 7 shows memory data processing generalized to multiple levels of hierarchy.

FIG. 8 shows processing for memories and predictions.

FIG. 9 shows memories and predictions for multiple levels in a hierarchy.

FIG. 10 shows an example of implementing the MRE in a parallel processing method.

FIG. 11a illustrated the concept of invariants using a tune recognizable in different musical keys.

FIG. 11b shows invariance in a tune is recognized regardless of the musical instrument on which it is played.

FIG. 11c notes that invariance allows a concept, a tune, to be recognized across different sensory inputs and different symbols.

FIG. 12 shows the storage locations in a p² memory pattern.

FIG. 13 shows the first stored p² memory pattern for a simple ascending signal sequence.

FIG. 14 shows the second stored p² memory pattern for a simple ascending signal sequence.

FIG. 15 is a flow chart illustrating the preferred embodiment of the method to perform the memory process and the prediction process of this invention.

### DETAILED DESCRIPTION

Example embodiments described herein with reference to the accompanying drawings, in which examples are illustrated are non-limiting. The present example embodiments may have different forms without departing from the present invention and the present invention should not be construed as limited to the descriptions set forth herein. Rather, the embodiments are provided so that this disclosure will be thorough and complete, and will fully convey the scope of the embodiments to those skilled in the art. Like reference numerals in the drawings denote like elements. In the drawings, the thicknesses of layers and regions are exaggerated for clarity.

The terminology used herein is for the purpose of describing particular embodiments only and is not intended to be limiting of the present example embodiments. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which the example embodiments belong. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

### Implementation

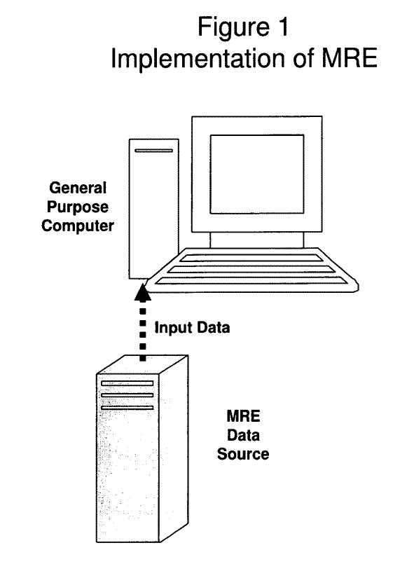

MRE is implemented in a general purpose computer. A data source for input data provides the data on which MRE will operate in a form that is computer readable. This may be from measurement apparatus, telemetry, other computers or from a source within the computer such as user input from a keyboard. This is illustrated in FIG. 1.

### Basis Elements

Basis elements are quantum data elements chosen according to the lowest level information from the problem domain in which the MRE will operate, and depend on the basic information element structure of the problem. Basis element examples include:
1. The letters of the arabic alphabet, 26 of them, if the problem is recognizing word-based memories.
2. The arabic numerals 0 through 9, if the problem is recognizing number-based memories.
3. The binary elements 0 and 1, if the problem is recognizing digital memories.
4. The notes A through G, if the problem is recognizing simple musical note-based memories.
5. The barcode elemental codes, if the problem is recognizing bar code memories. Similar for any type of code, such as Morse, Braille, etc.
6. The nucleotides A (adenine), C (cytosine), G (guanine) and T (thymine) if the problem is recognizing DNA sequences.

The basis elements must span the space of possible elements. In vector notation they look like [blank, blank, . . . , blank, element, blank, . . . , blank], with the element taking all possible locations in the basis vectors.

### The Memory Principle

Input data to the MRE may be in the form of sequences of basis elements or may be temporal as time series data from sensors, telemetry, etc. Input data is spatial in the sense that it is an n-tuple defined over the space of the basis elements. Input data may be a finite series of basis elements such as alphabetic letters in a book or court decision, or nucleotides in a genome.

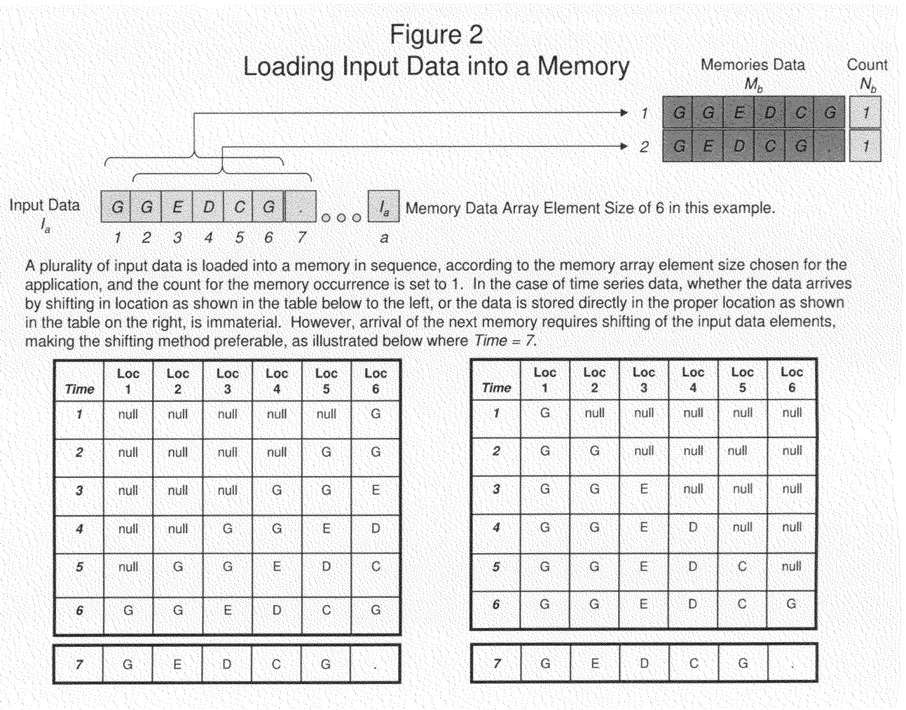

From the input data, one or more of the basis elements are grouped in sequence to form a memory data store, hereafter referred to as a memory, with the number of basis elements chosen to loosely fit the context of the problem domain and to be fixed through the operation of an instance of the MRE. This is illustrated in FIG. 2 and is shown as an example with 6 basis elements used to form a memory. The number of basis elements forming the memory is referred to as a frame in the figures.

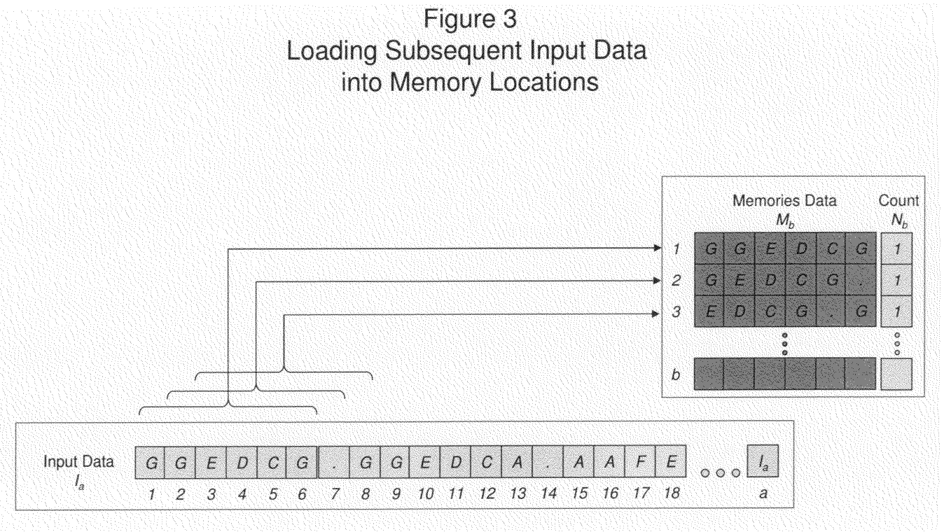

Subsequent occurrences of input data are grouped and stored as subsequent memories, as shown in FIG. 3. This forms a memory data array in the computer. Note that the illustration example is simplified to show the results of only unique memory occurrences.

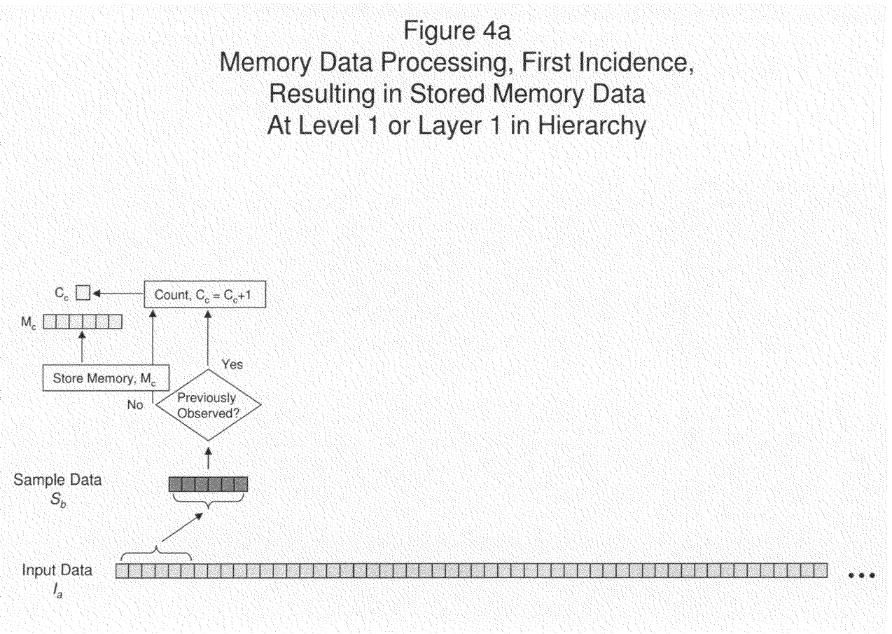

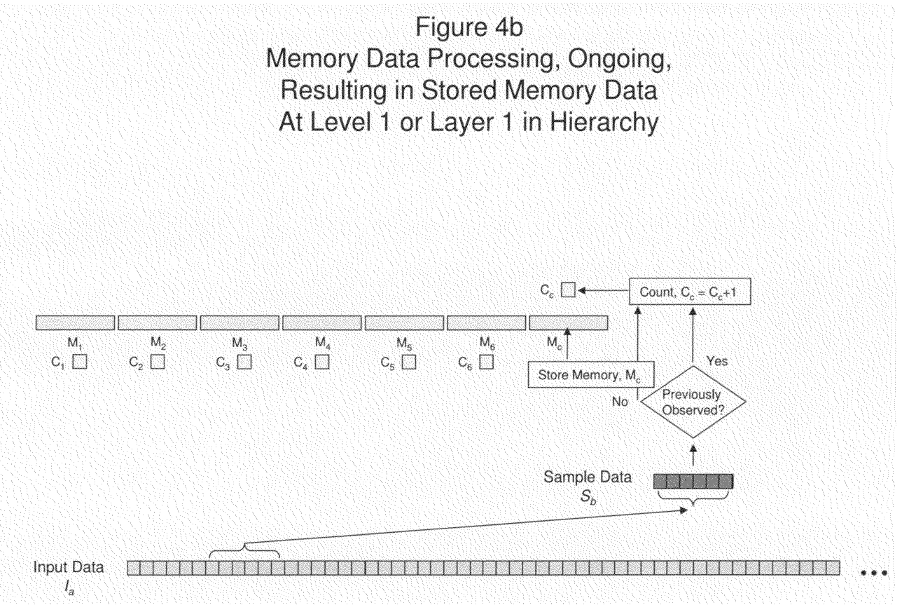

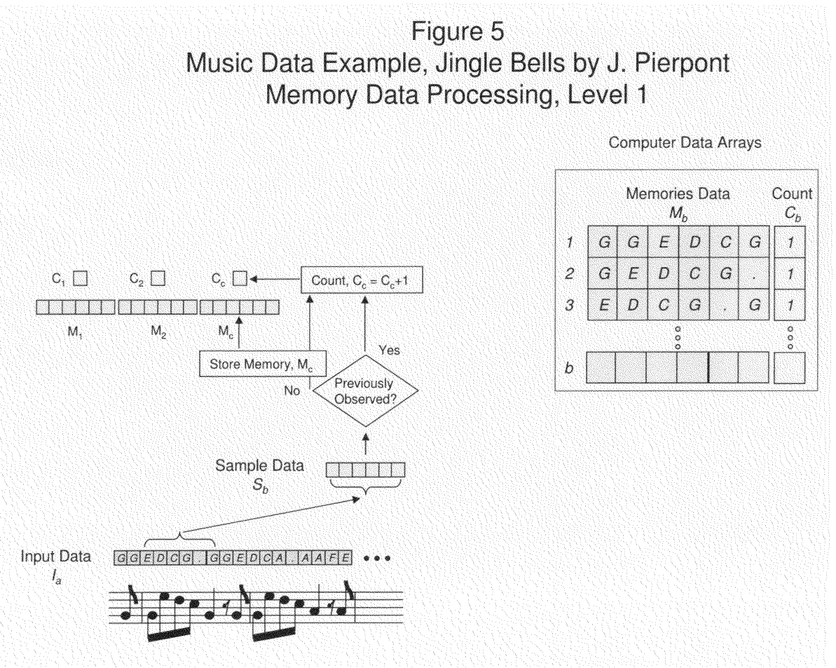

When a memory is observed and stored for the first time, it is assigned a memory occurrence count value of 1. When a memory is observed that has been stored previously, its memory occurrence count is increased by 1 and it is not stored again. This computational logic for the first memory from input data is shown in FIG. 4a. Subsequent memory processing occurs as illustrated in FIG. 4b. FIG. 5 illustrates the memory processing of input data consisting of notes from the tune, Jingle Bells, by J. Pierpont (Pierpont, J., “One Horse Open Sleigh”, Boston: Oliver Ditson & Co., deposited 1857 with Library of Congress).

Memory processing continues in the case of finite input data, until the input data is exhausted. This is the case when processing a song, book or genome for example. In the case where the input data set is indeterminately large, then the data array sizes in the MRE are set to be very, very large and processing can continue seemingly indefinitely.

The result of the memory principle is that all information that is seen is stored in the memories, and that some of them have larger memory occurrence counts than others. The MRE stores memories of everything it observes, that is, all data sequences it processes.

Memories may be stored using different conventions. If the objective is to record changes only independent of time, then an event-driven storage practice could be used where a new information row is added only after an information change. If the objective is to record durations of unchanged information, then a periodic storage practice could be used where information that is unchanged is stored in memory regardless of whether the information had changed or not. This latter practice results in duplicate rows in stored memories.

### The Memory Hierarchy—Layers and Levels

The MRE processing described so far has involved inspecting segments of input data, storing each unique memory in a memory data array, and incrementing the occurrence count in a corresponding count data array of each non-unique memory subsequently observed. This has been referred to as one layer, Level 1, in the figures.

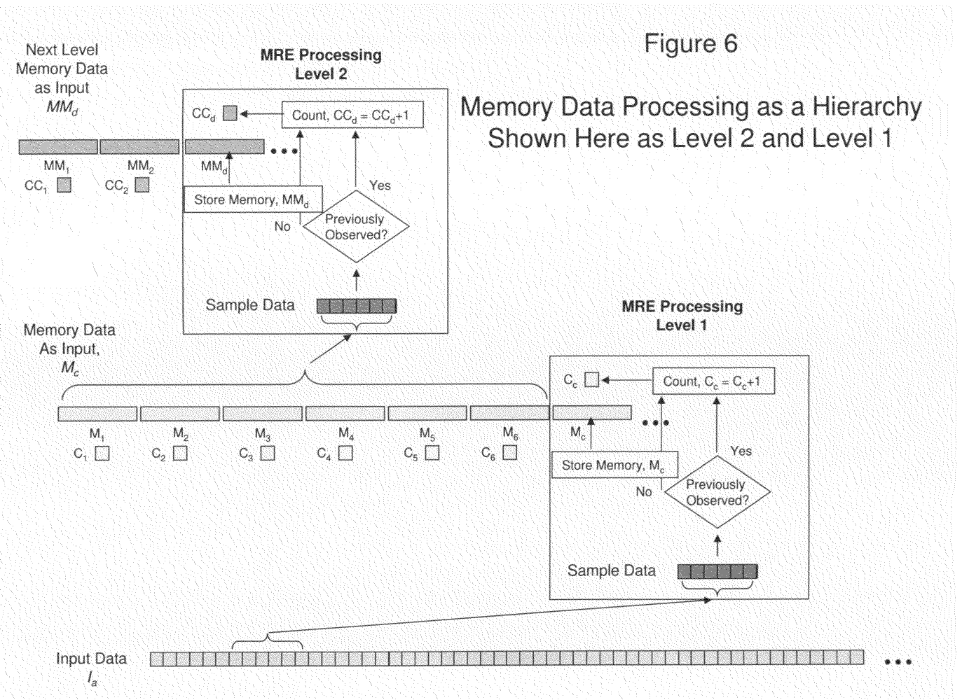

The same method is performed using the results of Level 1 as the input data sequence to a second layer or level of memory data processing. That is, a grouping of memories are gathered and stored in another memory with a memory occurrence count of 1. Subsequent gathered memories are inspected, stored if unique in yet another memory data array, and yet another corresponding occurrence count is incremented for each non-unique higher level memory observed. This results in a hierarchy of memory processing and is illustrated in FIG. 6 for 2 levels.

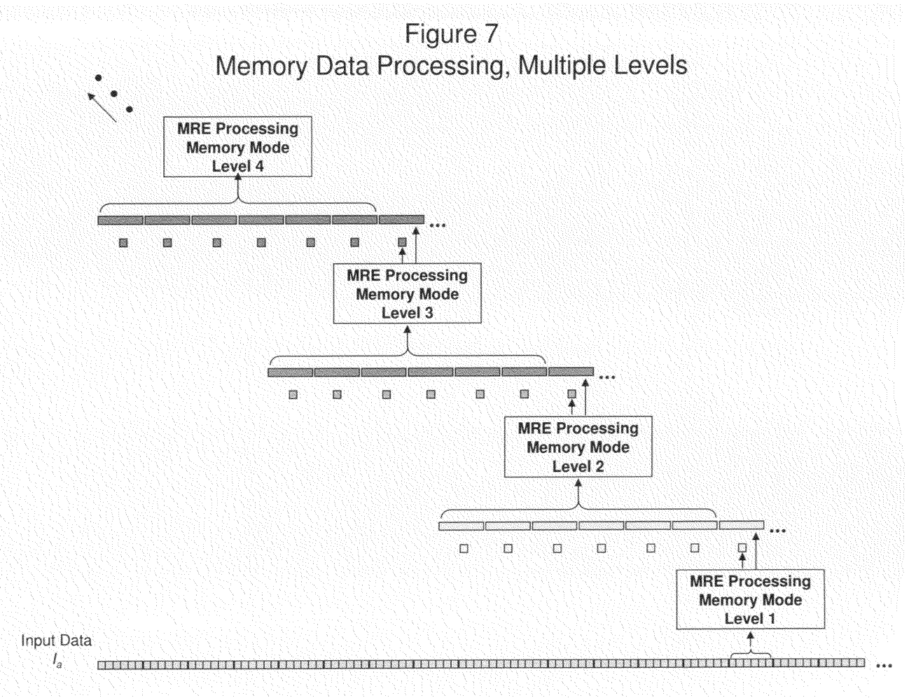

This method of successive layers of memory data processing may be continued as shown in FIG. 7, resulting in layers of memory data arrays and the corresponding memory occurrence count arrays.

### Predictions

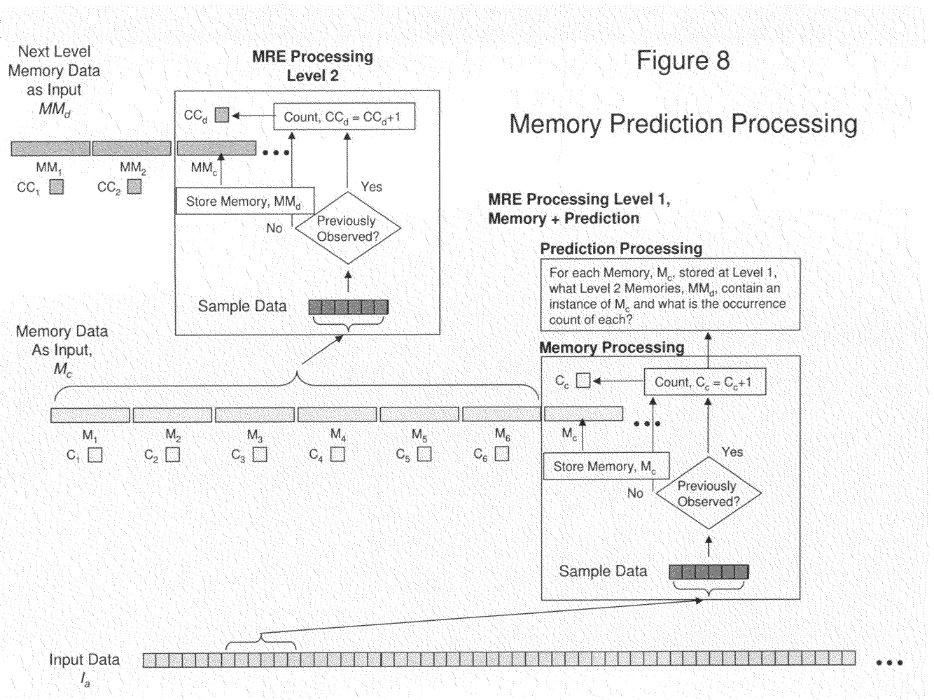

After some memories have been processed and the memory data arrays have been populated at least at 2 levels, then when a new memory arrives, the memory data array at the next level or layer in the hierarchy is inspected to determine if any stored memories at that level contain the subject data element. Any stored memories containing an element match are presented with their respective memory occurrence counts for processing appropriate to the application objective. This is illustrated in FIG. 8.

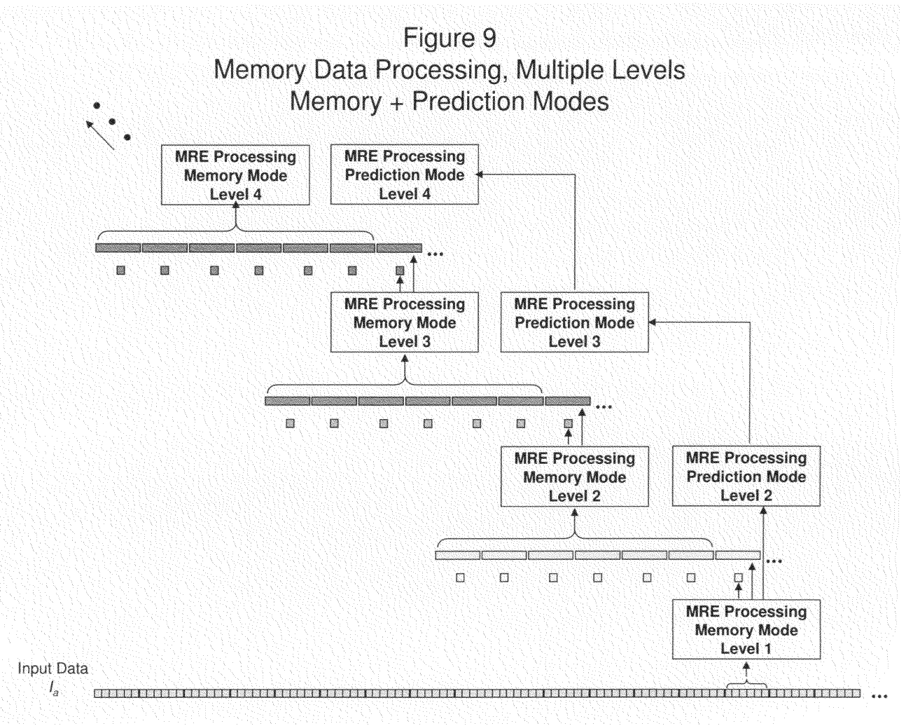

In the same manner that memory layers are built in a hierarchy, each successive level up can be processed for predictions. This is illustrated in FIG. 9.

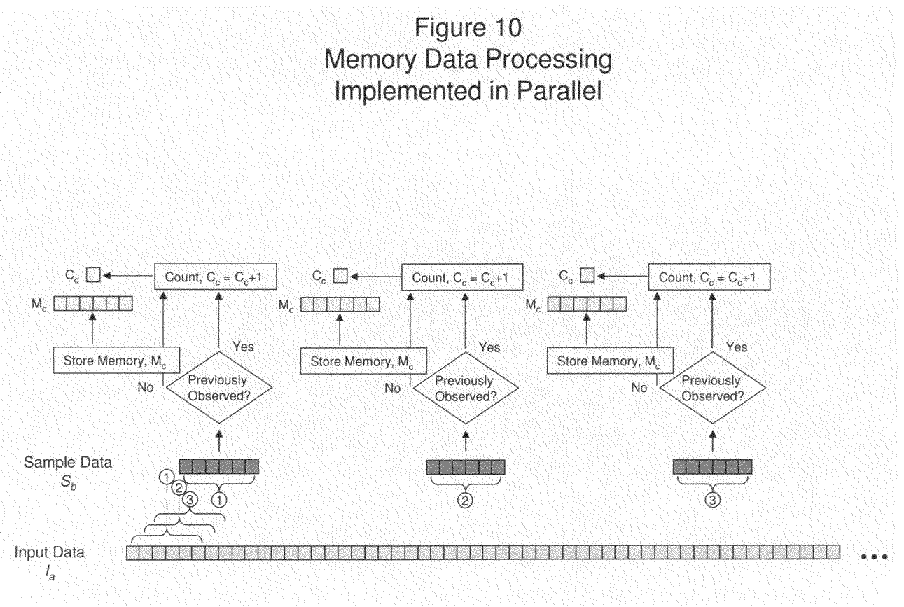

MRE is advantaged with prediction computations in advance of new signals, measurements or observations. These can be accomplished by means of: high speed computing apparatus; computationally efficient search algorithms readily available in the art; segmenting the problem and applying computations in parallel, as shown in FIG. 10, and; any combination of the aforementioned.

Prediction matches may be profound. For example, they may be form the basis for making anticipatory internet searches and presenting the results in advance of a computer user requesting them, based on the patterns previously expressed, and in so doing reduce the actions required of a user to satisfy routine or subsequent requests, or to improve relevancy of results when previous patterns are available from which to predict. Similarly, predictions may be used for anticipating shopping selections based on previous buying patterns, aiding the user in finding items or materials required. This may be particularly beneficial when a new user is offered selections based on other users previously in a similar circumstance, such as buying a house, completing a mortgage application, buying music, buying new technology components, buying equipment which require consumable supplies, etc.

Prediction matches may be used for advantage in manufacturing processes. For example, many discrete, batch, semi-continuous or continuous manufacturing processes will produce product within quality specification if input materials are within specification and equipment operates at or within performance specifications. Monitoring materials and equipment performance, and more specifically prediction matches resulting from materials and equipment performance may form the basis to release product to ship as soon as it is manufactured, eliminating a costly delay for quality testing. This often yields substantial inventory carrying cost savings. Conversely, prediction mismatches in this scenario, known sooner than available from after-the-fact quality testing, afford the opportunity for faster interventions and remedial actions resulting in less off-specification product.

Predictions may be used to offer users completions of text in routine business correspondence, speech to text applications and language translations. Technical support help-desks, product support for call centers, etc. would be similarly benefited.

Predictive actions may be performed in advance of situations which could have undesired outcomes, for the purposes of avoiding or mitigating the undesired outcomes. Examples include start-up and maintenance of complex equipment, monitoring manufacturing processes, game play, etc.

Prediction non-matches may also be profound. For an experienced system, that is one which has a robust set of stored memories, a non-match during prediction would indicate a novel data input. Additional computing resources may be called upon when such resources are finite, as may be appropriate for the application. For example, electrocardiograph data for thousands of individuals comprises an experienced system and new patient data resulting in a prediction non-match is the basis for rapid attention from a medical professional.

Continuous, semi-continuous and batch processes are often comprised of pipelines, tanks, vessels, reactors, etc. These are usually outfitted with measurement, control and alarm systems where the alarms are intended to alert human operators of abnormal or dangerous conditions. Because of physical laws, namely conservation of materials and conservation of energy, many operating parameters are interconnected, and any excursion from normal usually results in a cascade of other, connected parameters which subsequently diverge from normal. This results in cascades of alarms which fall into patterns, with the patterns having arisen from the physical connections of pipe, tank, vessel, etc. and the physical laws playing out. Here, a pattern non-match predicted from an experienced system may be profound and may, for example, indicate a catastrophic failure of a pipe or vessel. Such an indication may be important in mitigating safety and environmental risks.

Non-matches can be of value in genetic applications where novel expressions, mutations or responses are of greatest interest.

Non-matches observed or predicted in financial systems may indicate anomalies attributable to fraud, theft or mistakes. Medical insurance claims, for example, exhibit patterns arising from population demographics and epidemiology. Non-matches may be indications of fraud or new disease outbreaks.

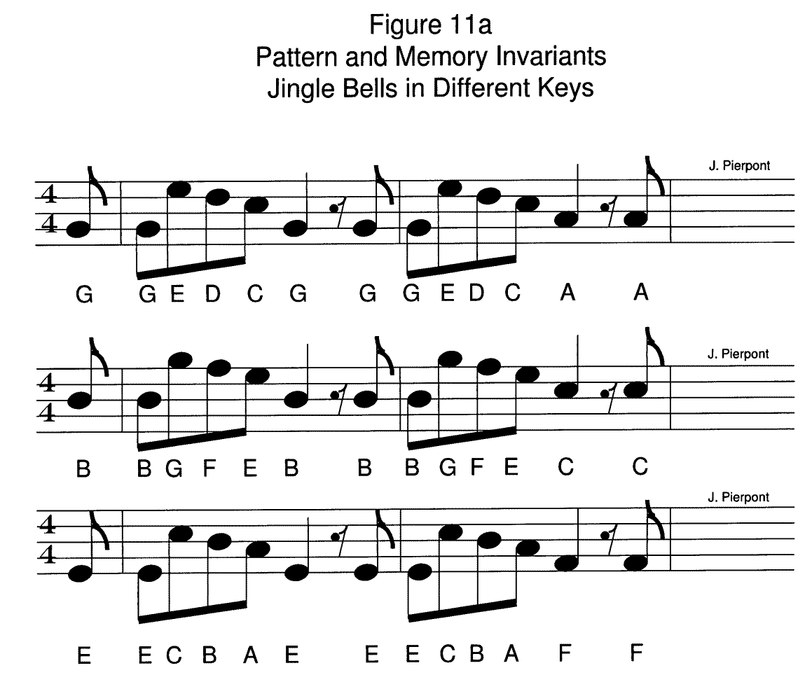

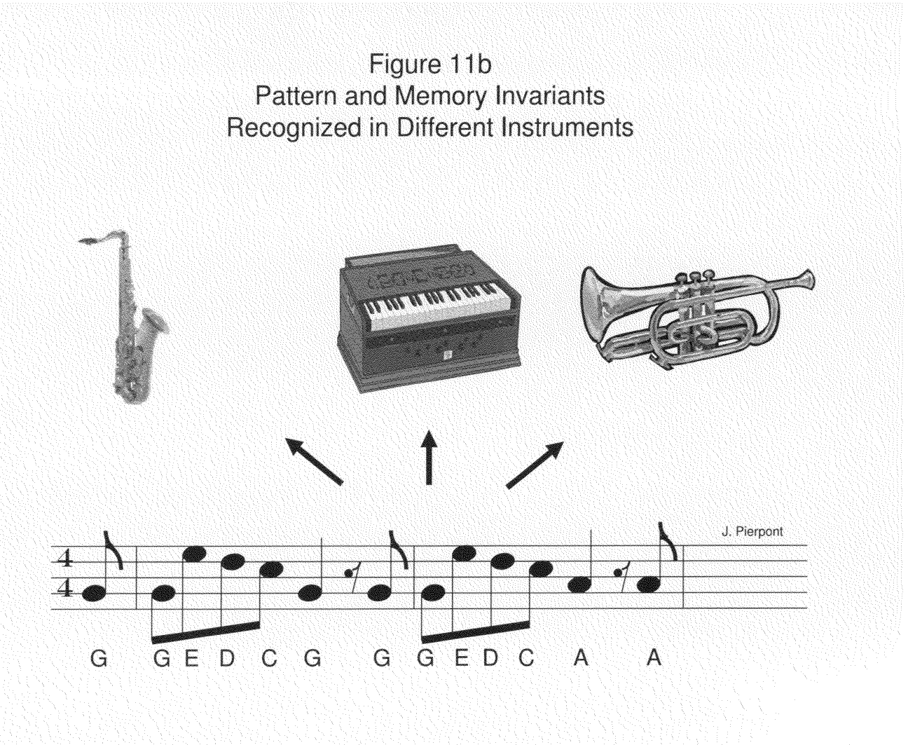

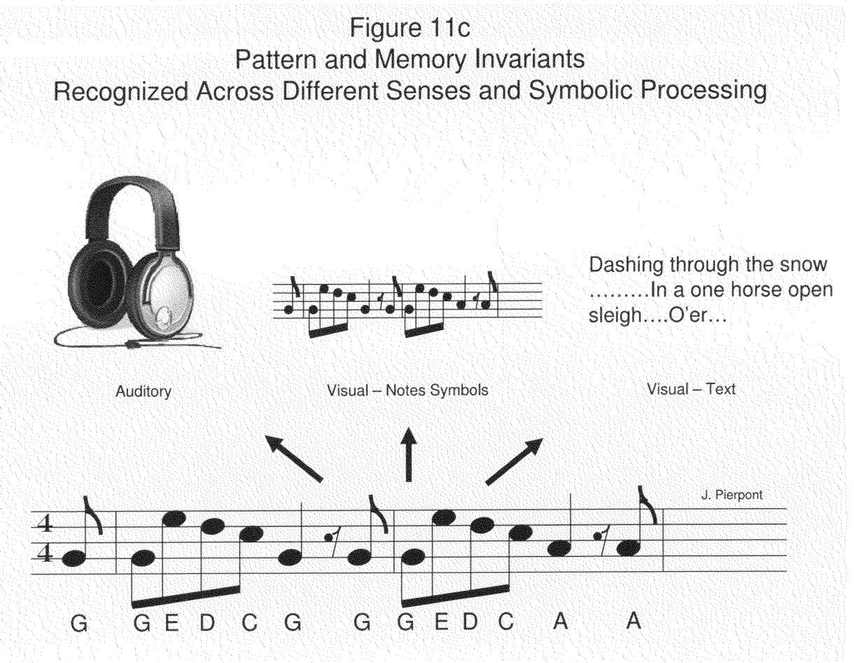

Invariant forms of memories, higher level memory objects, transformed or abstracted, to allow a pattern to be recognized or associated with a concept regardless of the noise, variation, diversity or even form of the input data, is part of the MRE. FIG. 11a illustrates the familiar invariant that allows people to recognize a concept, in this case a simple rendition of the tune Jingle Bells, regardless of musical key. FIG. 11b illustrates the invariance when people recognize the same tune given very different input data, from different musical instruments in this case. At an even higher level, invariance allows people to recognize the concept of Jingle Bells, across different sensory input and symbols as illustrated in FIG. 11c.

### MRE Testing and Observations

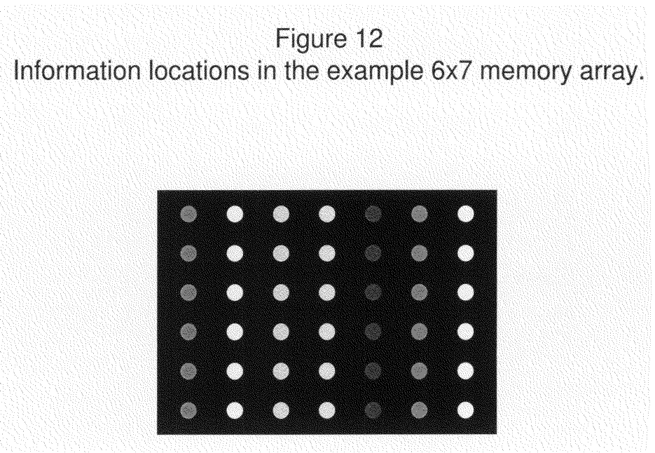

A MRE demonstration and test bed has been implemented by programs, and therefore, reconfigures the central processing units in a general purpose computer. The MRE demonstration and test bed can be implemented by a program written in the Visual Basic programming language. The use of Visual Basic is for convenience only. MRE can be implemented in many common computer programming languages including C, C++, Java, PHP, Perl, Python and many others. The MRE demonstration and test bed has a graphical user interface for interactive demonstrations of the MRE in memory and prediction modes. The graphical representation uses colored dots to represent information locations in the horizontal spatial dimension, and rows of these dots to represent sequential events in the vertical time dimension. This is illustrated in FIG. 12.

### Memory Mode

In FIG. 12 all information locations are shown for illustration. In one row each dot has a Red, Green, Blue (RGB) value. From left to right, the values are: R, R+G, G, G+B, B, B+R, R+G+B. Colored dots are chosen for illustration purposes because they are easy to follow visually in the demonstration. There are seven dots because there are seven fundamental RGB combinations. These are the basis elements for this demonstration. Six rows were chosen because of the six levels in the neocortex although for the purposes of the MRE this number is arbitrary. In practice the number of information locations and the number of rows are adjusted to fit the application.

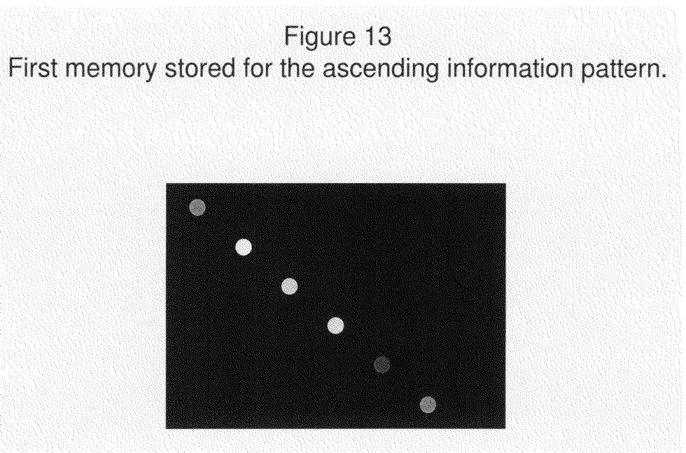

For the ascending pattern demonstration, once the six rows are filled, then the first memory is stored. This is shown in FIG. 13.

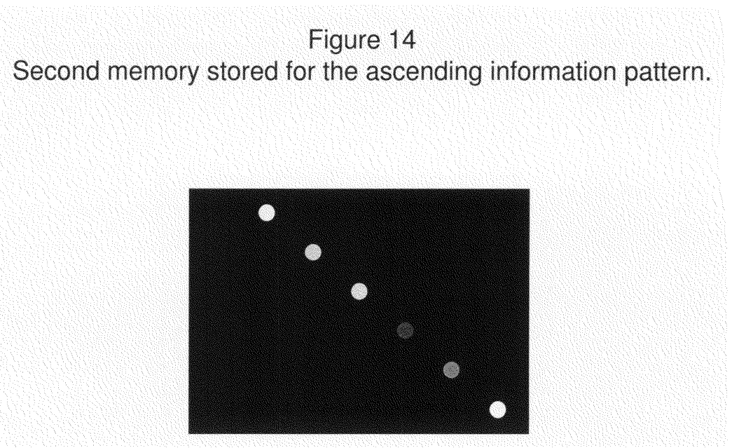

Since in this graphic implementation information rows scroll up, the time sequence flows from the top of the memory array and moves down, with the most recent sample data occupying the bottom row. In the ascending pattern demonstration, starting from the memory shown in FIG. 13 and after another information row is input, then the second memory is stored. This is shown in FIG. 14.

This process continues as long as new data elements, information rows in this case, are provided.

So in this demonstration a memory is simply a 6×7 matrix of values, represented by colors.

In practice the values can be anything, and the matrix can be any size.

### Prediction Mode

Given six rows of information in prediction mode, recalling from the discussion above that first a memory is stored and that memory is checked against all memories stored in the memory mode and the number of rows that match for each memory in the memory mode is indicated.

After several memories have been stored and tested in the prediction mode, then three more things happen:
1. Patterns of sequential memories are identified,
2. Patterns of sequential patterns are identified, and
3. A high-level invariant is used to identify patterns of patterns.

Now, since the individual information row is in itself a pattern, then the MRE recognizes that pattern, the memory made of 6 sequential patterns, patterns of those patterns, and patterns of patterns of those patterns. In other words, the MRE recognizes patterns four levels deep.

### The Power of MRE Prediction

The power of the MRE is observed in prediction. Upon observing the MRE demonstration it is very clear that the higher levels of recognition happen very quickly, even with bad information or information dropouts. This means that the MRE can be used to predict patterns long before they fully unfold.

### Patterns and Patterns of Patterns

There are three basic structures to the MRE:
1. Patterns occur as sequences.
2. Patterns are hierarchical in that there are patterns of patterns.
3. Higher-level patterns are formed using invariants in the spatial and/or temporal domains.

The algorithm starts by recognizing a single data element, which may be a measurement or signal pattern, then a pattern of data elements, then a pattern of patterns of data elements, and finally a pattern of patterns of patterns of data elements. This four-level hierarchy can be likened to music, where:
1. Level 1 is a single note or chord.
2. Level 2 is a bar of notes or chords.
3. Level 3 is a phrase of bars.
4. Level 4 is a song of phrases.

### Example MRE Applications

In the example of a Song application, there are 4 levels of memory information: notes or chords, bars, phrases, and songs. These are patterns, patterns of patterns, patterns of patterns of patterns, and patterns of patterns of patterns of patterns. The Song application is 4 levels deep.

To summarize the Song application:

### Song

Basis: Notes, in terms of the colors, arranged from left to right as R, R+G, G, G+B, B, B+R, R+G+B basis elements. One note or chord may be composed of the union of any combination of basis elements, plus the null element.
Memory: 6 notes or chords in sequence, designated a “bar”
Pattern: Any number of memories in a sequence that form a pattern, designated a “phrase”.
Overall: Any number of phrases in a sequence, designated a “song”.
There are other examples which are also 4 levels deep:

### Words

Basis: 26 letters, one per basis element. The basis width is 26.
Memory: X letters in a sequence, designated a “partial word string”
Pattern: Any number of partial word strings in a sequence that form a pattern, designated a “word string”.
Overall: Any number of word strings in a sequence, designated a “story”.

### Numbers

Basis: 10 numbers, 0 through 9, one per basis element. The basis width is 10.
Memory: X numbers in a sequence, designated a “group”.
Pattern: Any number of partial groups in a sequence that form a pattern, designated a “family”.
Overall: Any number of families in a sequence, designated a “family string”.

### Digital

Basis: A bit, which can take on the values 0 and 1. The basis width is 2.
Memory: 8 bits in a sequence (could be 16 or 32), designated a “byte”.
Pattern: Any number of bytes in a sequence that form a pattern, designated a “word”.
Overall: Any number of words in a sequence, designated a “word string”.

### Musical Notes

Basis: Notes A through G (simple version). The basis width is 7. A more complicated version would use 88 notes, to emulate the keyboard of a piano. In that case the basis width is 88. One note or chord may be composed of the union of any combination of basis elements, plus the null element.
Memory: X notes or chords in sequence, designated a “bar”.
Pattern: Any number of memories in a sequence that form a pattern, designated a “phrase”.
Overall: Any number of phrases in a sequence, designated a “song”.

### Code

Basis: X code elemental codes, with one code only in each basis element. The basis width is X.
Memory: Y elemental codes in sequence, designated a “partial message string”.
Pattern: Any number of partial message strings in a sequence, designated a “message string”.
Overall: Any number of message strings in a sequence, designated a “message super string”.

### Genetic Code

Basis: Four base nucleotides: A (adenine), C (cytosine), G (guanine) and T (thymine). The basis width is 4.
Memory: Y nucleotide codes in sequence, designated a “slice”.
Pattern: Any number of slices sequence, designated a “segment”.
Overall: Any number of segments in a sequence, designated a “genome”.

### The Memory Count Invariant

Upon observation of the memory counts for adjacent memories in the storage array, it can be seen that they display patterns that are at a higher level than the memories themselves. These patterns indicate the relative periodicity of sequential memories. For demonstration purposes, consider the “Sine” song that is composed of three superimposed sine waves with different frequencies and phase shifts. The Sine song generates notes or chords that run back and forth across the notes “keyboard” (the colored dots in a row) with often two and sometimes three adjacent notes. This song is good for demonstration purposes as it is quite complex, and generates 89 memories and has 3 non-patterns, designated as “holes” (one at the end of the memory array). With these features the Sine song demonstrates all aspects of MRE memory and prediction modes.

Upon loading the Sine song into memory, the first 12 memories have the following memory occurrence counts:
6 6 6 3 3 6 6 6 5 8 8 8 6
   There are clearly patterns of adjacent memory occurrence counts, some running for 3 or 4 memory locations.

### The Pattern Invariant

If one marks the edges, where the memory occurrence count changes by 2 or more, you get:
6 6 6 1 3 3 1 6 6 6 5 1 8 8 8 1 6

Note that the pattern invariant has abstracted out the information contained inside the pattern, it only sees that a pattern is there. In other words, the pattern invariant applies to any type of memory recognition problem. It would apply to the song, word, number, digital, note, code and genetic memory recognition problems mentioned above.

### The Hole Invariant

To demonstrate a non-pattern, something that does not repeat often enough to be useful for memory recognition, examine again the results of loading the Sine song into memory, but this time look at the memory counts for memories 23 through 44:
9 9 9|3 3|1 1 1 1 1 1 2 2 2 2 2|4 5 5 5 5 5

Now there is a non-pattern, or “hole” indicated by the string 1 1 1 1 1 1 2 2 2 2 2. While the first pattern in the above has an average memory count of 9, the non-pattern string still has over ½ of it which has been seen only once. It is not useful for memory recognition and as such is a non-pattern or hole in the string of memory patterns. These holes naturally occur on the transitions between songs. They also occur in the Sine song, in fact there are three holes in the Sine song, the largest one being at the end.

With regard to holes the number 2 is important again. If the average memory count of a possible pattern, as indicated by the edges, is less than 2, then it is a non-pattern or hole.

To elaborate, a memory count of 1 in a pattern indicates that that memory has only been seen once during memory processing. If a part of the pattern includes memories with a count of one, then more memories in that pattern with a memory count of 2 don't really matter, since the front of the pattern has only been seen once, which is indicative of a non-pattern in the sequence. The only way that the potential pattern can qualify as a pattern and not be judged as a non-pattern, is for the average memory count within the identified potential pattern to be 2 or greater.

### The Ratios Invariant

Look again at the first 12 memory counts for the Sine song:
6 6 6|3 3|6 6 6 5|8 8 8|6
   One can calculate the average memory count within each pattern, and write the averages in the same format:
6|3|5.75|8|6
   The ratios invariant is applied by simply taking the ratios of adjacent average memory counts, in succession, 2nd/1st, 3rd/2nd, 4th/3rd, 5th/4th, and 1st/5th. Applying this to the above example we get the ratios:
0.5|1.92|1.39|0.75|1

Note that the ratios invariant further abstracts out the information contained inside the pattern. In fact it is a direct indicator of the highest level pattern, the “song”. It is also generic and independent of the particular problem.

The ratios for a pattern sequence (a song, for example) converge quickly to near-constant values. The ratios invariant is a very powerful memory pattern recognition device.

### Ratios of Ratios

While even higher-level invariants (ratios of ratios, ratios of ratios of ratios, etc.) are conceivable, at this point they do not seem to add any practical value to the memory recognition algorithm.

### The Number 2

In the context of recognizing memory pattern edges, the number 2 is important. In fact, in the context of recognizing memory pattern edges, there are only three types of numbers, 1, 2, and more than 2.

It is not surprising that the number 2 is fundamental to the memory recognition problem. After all, many things in our world occur in 2's, Up/down, left/right, 0/1, right/wrong, on/off, in/out, male/female, positive/negative (electrical), N/S (magnetic). etc. The list goes on and on.

These examples point out the binary nature of many aspects of our world, and raise the question: what does the contribution of 2 to the recognizing of pattern edges have to do with binary? The answer is there is either an edge or not, which is a binary situation.

It also raises the question: what does the contribution of 2 to the recognition of holes have to do with binary? The answer is that for a potential pattern to be a valid pattern and not a hole is that the average memory count within the pattern be 2 or greater. In other words, it is either a pattern or not, which is a binary situation.

### The Memory Process as Implemented in the Test MRE

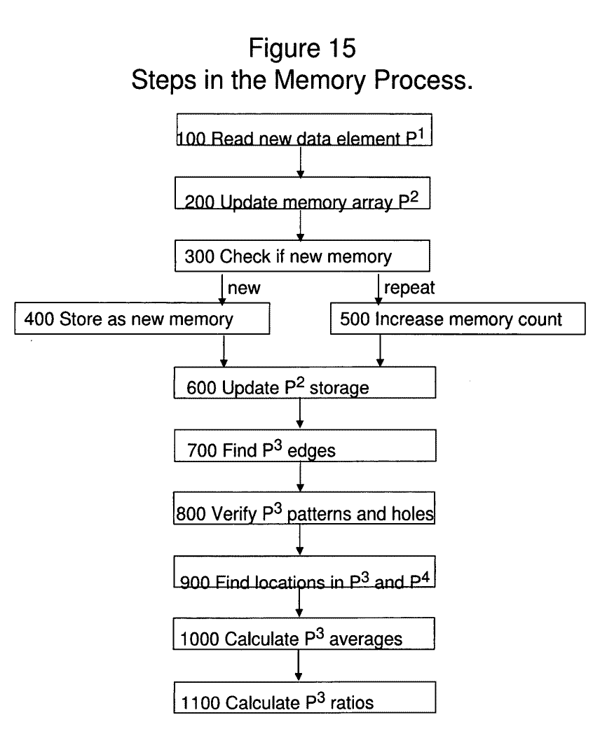

The memory process in illustrated in FIG. 15. There the nomenclature Pⁱ is introduced for brevity, where “P” denotes pattern and “i” denotes the pattern level. Thus P¹ is the pattern of the signal, p² is a pattern of P¹ patterns, etc.

Step 100 reads in a new sample data, P¹. This “reading” in may include signal conditioning, such as filtering or normalization.

Step 200 updates the p² memory array. This means shifting row 5 up to row 6, row 4 to row 5, etc., and placing the new sample data P¹ in row 1.

Step 300 checks if the p² memory is a new one or not. If it is, then step 400 stores it as a new memory with a memory count=1. If it is not a new memory, but rather is a repeat of a pre-existing memory, then in step 500 that memory's memory count is increased by +1.

Step 600 completes the memory update process by updating the p² storage array.

Step 700 finds p³ edges where the memory count changes by 2 or more.

Step 800 verifies p³ patterns and holes.

Step 900 finds and records the locations of the current p² memory in p³ and P⁴ patterns, and the locations of p³ in p⁴ patterns. In this step the identification of p⁴ is known as that is the “song” that is being read into memory.

Step 1000 calculates the average memory counts within p³ patterns.

Step 1100 calculates the ratios of adjacent p³ pattern average memory counts.

### The Prediction Process

The prediction process is identical to the memory process, except now prediction memories, patterns Pⁱ, and p³ ratios are compared with those generated in the memory process. In this way patterns of different levels can be matched before the entire pattern is seen by the prediction process.

When comparing p² patterns in prediction mode with the p² patterns produced in memory mode, it is useful to allow other than complete matches to trigger a “fake” match. That is, when comparing in the example the six rows of the stored memory arrays, allowing 5 out of 6 or 4 out of 6, etc. to trigger a match. This creates a robustness that results in accurate prediction matches given measurement signal dropouts. In fact, tests with the demonstration system show that this procedure allows accurate matches to be made with roughly 50% of the measurement signal series removed.

All references are incorporated herein by reference for all purposes.

What is claimed is:

1. A method for in memory mode storing sequential information in a memory structure comprising a plurality of memory array rows, the method comprising the steps of:
parsing a first sample information of a plurality of sequential information into a plurality of data elements that determine a first row of the memory array rows, and placing the plurality of data elements in the first sample information in the first row of the memory array rows;
with a second sample information of the plurality of information, parsing the second sample information into a plurality of data elements, shifting the first row of the memory array rows up into a second row, and placing the second sample information into the first row of the memory array rows;
continuing shifting rows of the memory storing data by one up and placing into the first row of memory array row for subsequent sample information of the plurality of information until the plurality of memory array rows are filled, and then storing the plurality of information as a first memory, with a memory occurrence count of one;
with the next sample information, parsing the next sample information into a plurality of data elements, deleting a top row of the memory array rows, shifting all rows below the top row up one row, and placing into the first row the next parsed sample information, and comparing total memory array with all previously stored memories, and:
if it is a copy of a previous memory, increasing the total memory array's memory occurrence count by one,
if it is a new memory, storing the total memory array as a new memory with a memory occurrence count of one; and
continuing the increasing or the storing, and recording a high-level pattern from which information for the total memory comes until all sample information of the plurality of information has been processed;
wherein the recording sets up an information array that indicates which memories in the sequence of stored memories associate with which high-level patterns.

2. The method according to claim 1, further comprising:
evaluating a list of sequential memory occurrence counts for all memories, starting with the first and ending with the last, wherein the list embodies a memory count invariant;
finding edge information of patterns of sequential memories, where a memory occurrence count changes by two or more, wherein the edge information of patterns embodies a pattern invariant;
storing the edge information of patterns within the high-level pattern relative to the beginning and end of the high-level pattern so that location information for the patterns of sequential memories within the high-level pattern is set up;
calculating an average memory occurrence count for each of the patterns of sequential memories;
finding holes in pattern sequences which are indicated by an average memory count less than two, wherein the holes embody a hole invariant;
calculating ratios of adjacent pattern memory counts, wherein a second pattern memory count is divided by the first pattern memory count, a third pattern memory count is divided by the second pattern memory count, and a last pattern memory count is divided by the first pattern memory count, and wherein the ratios embody a ratios invariant.

3. The method according to claim 2, further comprising:
parsing a first sample information of a plurality of sequential information into a plurality of data elements that determine a first row of a prediction memory array and placing plurality of data elements in the first sample information in the first row of the prediction memory array;
with a second sample information of a plurality of sequential information, parsing the second sample information into a plurality of data elements, shifting the first row of the prediction memory array up into a second row, and placing the data elements of the second sample information into the first row of the prediction memory array;
continuing shifting rows in the prediction memory array up and placing into the first row for subsequent sample information of the plurality of information until the prediction memory array is filled, and storing the plurality of information as the first prediction memory, with a memory occurrence count of one;
checking the prediction memory array against the previously stored memories for row matches, wherein a perfect match is all rows matching;
for matched memories, locating expected patterns and expected high-level patterns that contain the matched memories;
calculating the prediction invariants and using the prediction invariants to compare with the memory invariants to indicate predicted matches in patterns and high-level patterns;
with the next sample information, parsing the next sample information into a plurality of data elements, deleting a top row of the prediction memory array, shifting all rows of the prediction memory array below the top row up one row, and placing into the first row the next parsed sample information, comparing total prediction memory array with all previously stored prediction memories, and:
if it is a copy of a previous prediction memory, increasing the prediction memory's memory occurrence count by one,
if it is a new prediction memory, storing it as a new prediction memory with a memory occurrence count of one; and
continuing the increasing or the storing prediction memories until all sample data have been processed or until a conclusive pattern match has been made.

4. The method cited in claim 3, wherein less than a full number of rows from the memory array matching indicates a fake match, and wherein a fake match indicates the robustness of the system allowing matching to be accurate given signal data dropouts.

5. The method cited in claim 3, wherein limited sample data elements or incomplete sample data are provided.

6. The method cited in claim 3, further comprising using a memory count invariant for the prediction memory array.

7. The method cited in claim 3, further comprising using a pattern invariant for the prediction memory array.

8. The method cited in claim 3, further comprising using a holes invariant for the prediction memory array.

9. The method cited in claim 3, further comprising using the ratios invariant for the prediction memory array.

10. The method according to claim 1, wherein the plurality of sequential information are based upon a sample data sequence that is not finite and an upper bound established by an implementer.

11. The method according to claim 1, wherein there is no known or available high-level pattern and the methods operate based on observed memories.

12. The method according to claim 10, wherein there is no known or available high-level pattern and the method operates based on previously observed memories.

13. The use of the method of claim 1 in continuous process manufacturing.

14. The use of the method of claim 1 in discontinuous process manufacturing.

15. The use of the method of claim 1 in discrete process manufacturing.

16. The use of the method of claim 1 in web-based information-gathering, search, data-entry and order-completion applications.

17. The use of the method of claim 1 in biological and health-related applications.

18. The use of the method of claim 1 in chaos applications.

19. The use of the method of claim 1 in financial applications.
